(19) United States
(12) Patent Application Publication
(10) Pub. No.: US 2010/0096815 A1
(43) Pub. Date: Apr. 22, 2010

(54) Flexible coupling for attachments to a hand drill

(76) Inventor: Raymond Mackell, Standard (CA)

Correspondence Address: Antony C. Edwards, P.O. Box 26020, Westbank, BC, V4T 2G3, CA

(21) Appl. No.: 12/285,976

(22) Filed: Oct. 17, 2008

(51) Int. Cl. B23B 31/02; B23B 31/10

(52) U.S. Cl. 279/145; 408/239 R

(57) ABSTRACT

A flexible coupling for releasably mounting attachments to a hand drill includes a body having opposite first and second ends. A rigid shank is mounted to the first end of the body. The shank is elongate and extends from the body for mounting the shank in the chuck of the hand drill. A resilient sleeve is mounted on the second end of the body. The handle of an attachment such as a hand tool snugly inserts into the resilient sleeve and is thereby frictionally held in the sleeve and hence held in the chuck. The sleeve may be rolled into a storage position on the body, and unrolled along the handle to mount the handle to the body.

### FIELD OF THE INVENTION

This invention relates to the field of devices for converting drills for use with screwdriver bits and the like and in particular to a device for mounting attachments including hand tools such as screwdrivers and the like to the chuck of a hand drill.

### BACKGROUND OF THE INVENTION

It is known in the prior art to use corded and cordless drills as powered screwdrivers by the inter-changing of screwdriver bits for drill bits in the chuck of the drill. However, it is often the case that for example a user commences screwing fasteners using a hand tool such as a screwdriver only to find that the screwing of the fasteners may be more efficiently done using a drill with a screwdriver bit. However, it is time consuming for the user to abandon the hand tool, locate a drill, locate the screwdriver bits, mount the appropriate bit into the hand drill, and then recommence screwing of the fasteners. Consequently, it would be advantageous, and it is an object of the present invention to provide, an adapter for mounting in the chuck of a hand drill for flexibly coupling the hand tool or other attachment to the drill.

### SUMMARY OF THE INVENTION

In summary, the flexible coupling according to the present invention for releasably mounting attachments to a hand drill may be characterized as including in one aspect a body having opposite first and second ends, where a rigid shank is mounted to the first end of the body. The shank is elongate and extends from the body for mounting the shank in the chuck of a hand drill. A first end of a resilient sleeve having opposite first and second ends is mounted on the second end of the body.

The sleeve is furlable by hand between extended and retracted positions. The sleeve is oppositely disposed to the shank when the sleeve is in its extended position. When the sleeve is in the retracted position it is furled into an annular toroid around the axis of the body.

The second end of the body has a bearing surface across it. The first end of the sleeve is mounted around the bearing surface so that in its retracted position the annular toroid is around the bearing surface. Thus with the butt-end of an attachment for a hand drill seated against the bearing surface, the sleeve may be unfurled by hand from its retracted position to its extended position unfurled along the butt-end of the attachment. The sleeve is sized to resiliently encase the butt-end of the attachment when in its extended position. The sleeve is easily rolled into its extended, unfurled position on the handle using a simple roll-on/roll-off motion along the direction unfurling/furling respectively.

In one preferred embodiment the body is substantially cylindrical and the sleeve is a substantially cylindrical tube when in its extended position. The first end of the sleeve may fit over or otherwise mount to the second end of the body. Further advantageously, the sleeve may be a rubber-like cylinder having embedded therein Nylon™-cord braiding in a cylindrical criss-cross pattern.

Advantageously the sleeve when in its extended position is longer than the body. In one embodiment the length is at least twice the diameter when the sleeve is in its extended position.

Further advantageously, the sleeve when in its extended position is flexible so as to bend along its length whereby a rotation of the shank also rotates the sleeve along the bend. A pivotable coupling between the body and the shank may also be provided whereby the shank is pivotable relative to the body to thereby allow rotation of the body and sleeve by the drill when the attachment is not co-linear with the axis of rotation of the shank.

In a preferred embodiment the attachments may include hand tools such as screw drivers and the butt-end of the tools' handles fit snugly into a cup formed in the bearing surface of the body.

### BRIEF DESCRIPTION OF THE DRAWINGS

In the following figures wherein similar characters of reference denote corresponding parts in each view,

FIG. 1 is, in side elevation view, the flexible coupling according to the present invention in its roll up furled position being mounted to the handle of a tool.

FIG. 2 is, in right end view, the flexible coupling of FIG. 1.

FIG. 3 is, in side elevation view, the flexible coupling of FIG. 1 with the resilient sleeve in its unfurled extended position.

FIG. 4 is an end view of the flexible coupler of FIG. 3.

FIG. 5 is, in front perspective view, the resilient coupler of FIG. 3 mounted onto a screwdriver shown in dotted outline.

FIG. 6 is, in perspective view, the flexible coupling of FIG. 3 showing the sleeve unfurled in its relaxed state.

FIG. 7 is, in perspective view, the flexible coupling of FIG. 1.

FIG. 8 is, in partially exploded rear perspective view, the flexible coupling of FIG. 5, illustrating how the shaft may be angled relative to the body.

### DETAILED DESCRIPTION OF EMBODIMENTS OF THE INVENTION

The hand tool adapter 10 according to one embodiment to the present invention includes a cylindrical solid body 12 having opposite first and second ends 12a and 12b respectively. A shaft 14 adapted for mounting into the chuck of a hand drill (not shown) is mounted to the first end 12a so as to protrude therefrom. In its un-deflected position, shaft 14 extends along the centroidal axis of symmetry A of body 12. The second end 12b of body 12 is formed as a resilient cup 12d. Cup 12d is sized to receive snugly therein the distal end 16a of the handle 16b of a hand tool such as screwdriver 16.

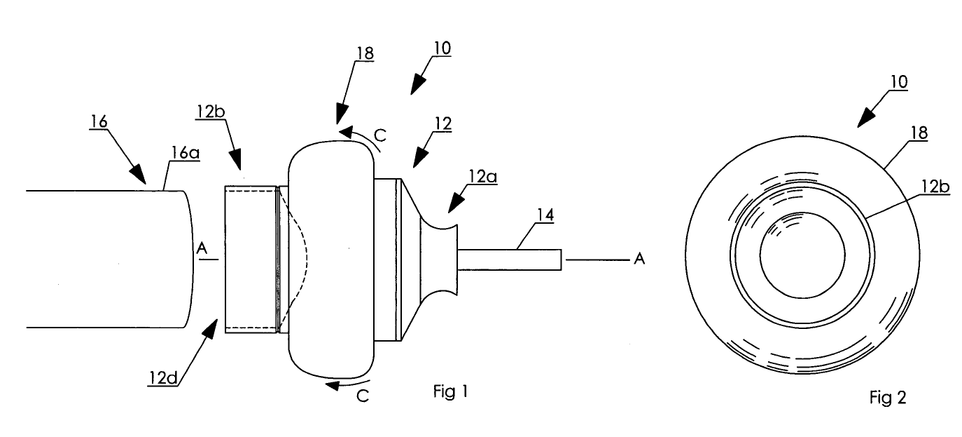

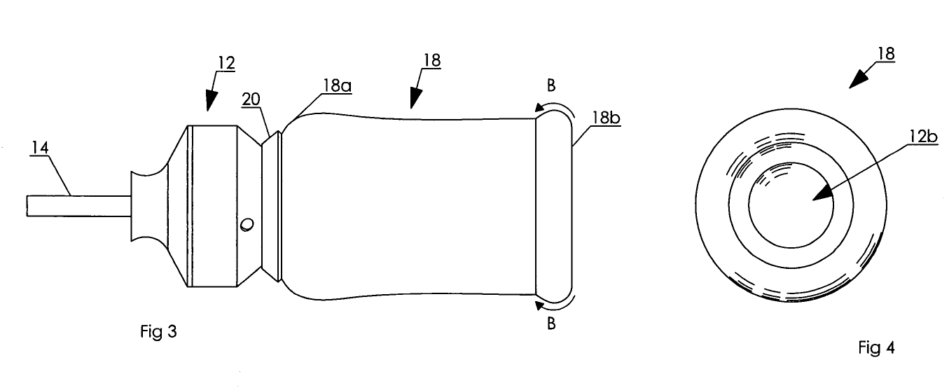

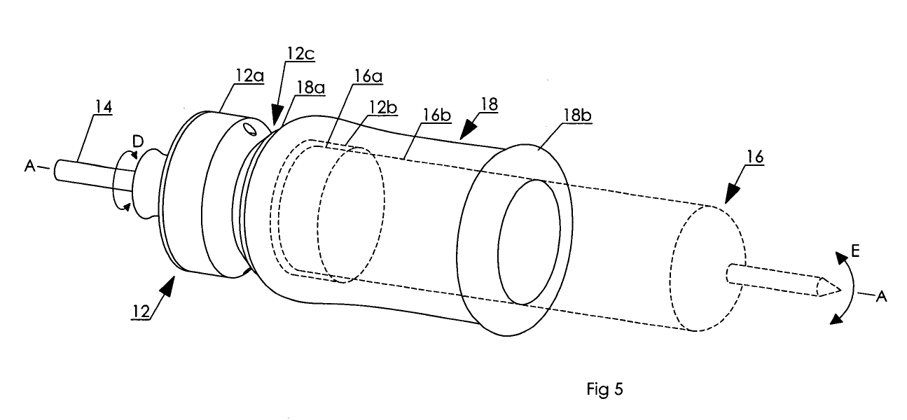

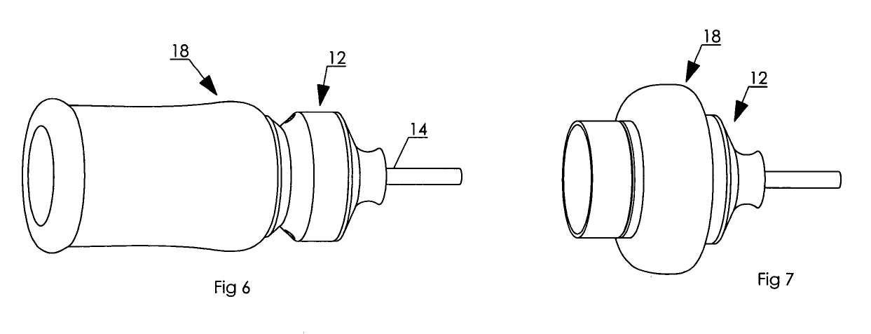

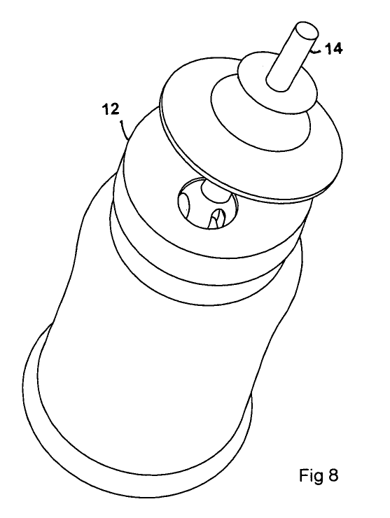

A resilient sheath or sleeve 18 having opposite ends 18a and 18b is mounted to cylindrical body 12 at first end 18a. Sleeve 18 may be secured by a band 20 or other fasteners to cylindrical body 12, for example by clamping end 18a in annular grove 12c. Annular groove 12c may be formed around the mid portion of cylindrical body 12 to retain therein end 18a for example by means of fastening band 20 encircling sleeve 18 to hold the sleeve in both its furled and unfurled positions. With the first end 18a of sleeve 18 mounted to cylindrical body 12, sleeve 18 may be rolled up in direction B from its unfurled position so as to store the sleeve in its furled storage position of FIG. 1 retracted onto the outer circumference of end 12b of cylindrical body 12. Sleeve 18 may be extended therefrom by the manual unrolling by hand of sleeve 18 in direction C. With handle end 16a inserted snugly into cup 12d, sleeve 18 may be unrolled so as to cover over end 12b and so as to cover over the handle 16b of screwdriver 16. With handle 16b mounted into cup 12d, resilient sleeve 18 snugly and frictionally engages handle 16b while allowing angular deflection of the handle in direction E relative to the cylindrical body 12 and thus relative to the drill. For example, the shaft 14 may be pivotable relative to the body 12 such as seen in FIG. 8. The internal end of shaft 14 may sit in body 12 in a pivotable socket, ball joint or other form of universal joint. This also provides for angular deflection while simultaneously rotating the attachment or tool with the drill.

Thus with sleeve 18 in its extended and unfurled position extended over the cup of the cylindrical body and handle of the screwdriver, the shaft may be mounted into the chuck of the hand drill, and the hand drill used to rotate the cylindrical body in direction D about centroidal axis A to thereby rotate the screwdriver 16.

Thus screwdriver 16 may be used for manually screwing fasteners (not shown) and may be quickly switched to power assisted screwing of the fasteners using the adapter 10 by merely inserting the handle of the screwdriver into the adapter and using a manual roll-on/roll-off hand action to quickly and easily couple and decouple the tool from the adapter.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. a flexible coupling for releasably mounting attachments to a hand drill comprising:
a body having opposite first and second ends,
a rigid shank mounted to said first end of said body, said shank elongate and extending from said body for mounting in the chuck of a hand drill,
a resilient sleeve having opposite first and second ends, said first end of said sleeve mounted on said second end of said body, said sleeve furlable between extended and retracted positions and oppositely disposed to said shank when in said extended position, said sleeve furled into an annular toroid when in said retracted position,
said second end of said body having a bearing surface thereacross, said first end of said sleeve mounted around said bearing surface so that in said retracted position said annular toroid is around said bearing surface,
and wherein with the butt-end of an attachment for a hand drill seated against said bearing surface said sleeve is unfurlable from said retracted position to said extended position unfurled along the butt-end, said sleeve sized to resiliently encase the butt-end when in said extended position.

2. The coupling of claim 1 wherein said body is substantially cylindrical and wherein said sleeve is substantially a cylindrical tube when in said extended position and wherein said first end of said sleeve fits over said second end of said body.

3. The coupling of claim 2 wherein said sleeve when in said extended position is longer than said body.

4. The coupling of claim 2 wherein said sleeve has a lateral diameter across said tube and has a length along said tube perpendicular to said diameter, and wherein said length is at least twice said diameter when said sleeve is in said extended position.

5. The coupling of claim 4 wherein said sleeve when in said extended position is flexible so as to bend along said length whereby a rotation of said shank also rotates said sleeve along said bend.

6. The coupling of claim 1 further including a pivotable coupling between said body and said shank whereby said shank is pivotable relative to said body.

7. The coupling of claim 5 the coupling of claim 1 further including a rotational coupling between said body and said shank whereby said shank is pivotable relative to said body.

8. The coupling of claim 1 wherein said bearing surface is cup shaped.
